(19) United States
(12) Patent Application Publication
(10) Pub. No.: US 2010/0090779 A1
(43) Pub. Date: Apr. 15, 2010

(54) METHOD OF ORTHOGONAL-MODE JUNCTION COUPLING WITH A MEDIUM TO BROAD OPERATING BANDWIDTH, AND COUPLER EMPLOYING SAID METHOD

(76) Inventors: Lars Foged, Apilia (IT); Andrea Giacomini, Albano Laziale (Rome) (IT)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/446,973

(22) PCT Filed: Oct. 18, 2007
(86) PCT No.: PCT/EP07/61135

§ 371 Date: Apr. 23, 2009

(30) Foreign Application Priority Data
Oct. 24, 2006 (FR) 06 09334

(51) Int. Cl. H01P 5/19; H01P 5/12

(52) U.S. Cl. 333/135

(57) ABSTRACT

Orthogonal-mode junction coupler with a medium to broad bandwidth for a waveguide (1) operating at a wavelength λ, characterized in that it includes a connector (5) projecting from the waveguide (1) and extending between a short circuit (3) of the waveguide (1) and a conducting structure (6) acting as dipole radiating at a wavelength of approximately λ/2 excited at its central point by the connector.

The present invention concerns a coupling method and a coupler implementing said method in order to separate dual-polarization bands spreading a horn antenna, for example.

In the field of radiofrequency antennas, it is well known to use orthogonal-mode junction couplers, or “ortho-mode junction” (OMJ) couplers, to separate dual-polarization bands.

For medium to broad operating band frequencies, these orthogonal-mode junction couplers are traditionally made up of a supply section of the waveguide comprising orthogonal supply points placed along the axis of the coupler, said points being offset along the axis of the coupler. The supply points are generally realized using connectors, grooves or any other equivalent means well known by One Skilled in the Art.

This type of coupler has the drawback of providing poor isolation between the various inlet ports of the supply points which are close to each other.

Furthermore, this type of coupler has an asymmetry which leads to degradation of the purity of the modal network due to the excitation of higher order modes.

In order to offset the coupling appearing between the different inlet ports of these couplers, it is well known to use an external compensating circuit ensuring supplying of the inlet ports. However, these compensating circuits do not allow the elimination of all errors.

One of the aims of the invention is therefore to resolve all of these drawbacks by proposing a coupling method and a coupler implementing said method obtaining weak coupling between the ports for medium to broad frequency bands without requiring an external compensating circuit.

According to the invention, what is proposed is an orthogonal-mode junction coupling method with a medium to broad bandwidth for a waveguide operating at a wavelength λ, said method being remarkable in that it consists of capacitively supplying a conducting structure integral with the waveguide through a connector projecting inside the waveguide and extending between a short circuit of said waveguide and the conducting structure.

Another object concerns an orthogonal-mode junction coupler with a medium to broad bandwidth for a waveguide operating at a wavelength λ, which is remarkable in that it comprises a connector projecting from the waveguide and extending between a short circuit of the waveguide and a conducting structure acting as a dipole radiating at the wavelength λ/2 excited at its central point by the connector.

Said connector consists of a conducting rod electrically isolated from the waveguide and capacitively supplying the conducting structure.

Furthermore, the conducting structure consists of two fins, C-shaped or U-shaped, respectively, extending symmetrically on either side of the plane of symmetry of the waveguide, each fin comprising a first branch integral with the waveguide and extending above the connector and parallel thereto toward the plane of symmetry of said waveguide, and a second branch extending parallel to the first branch above the latter part, said branches being connected by a vertical base extending perpendicularly to the connector.

The distance separating the short circuit of the waveguide of the lower connector is approximately equal to one quarter the wavelength λ of the waveguide.

The distance separating the lower connector from the upper connector is also approximately equal to one quarter of the wavelength λ of the waveguide. The upper connector using a virtual short circuit located under the latter part in the waveguide (for example made using a rod parallel to said connector connected at both ends to the walls of the waveguide).

In order to avoid the appearance of a parasitic mode in the waveguide 5, the coupler comprises a filter positioned between the two orthogonal excitation assemblies (filters made for example using rods connected at both ends to the walls of the waveguide).

It is understood that in order to obtain two orthogonal polarizations, one advantageously needs two conducting structure+connector assemblies, each assembly being orthogonal and placed so as to be superimposed with a distance of approximately lambda/4 between the lower connector and the upper connector.

Other advantages and characteristics will better emerge from the description which follows, of a single embodiment provided as a non-limiting example, of the orthogonal-mode junction coupler, in particular coaxial, with a medium to broad bandwidth according to the invention, from the appended drawings in which:

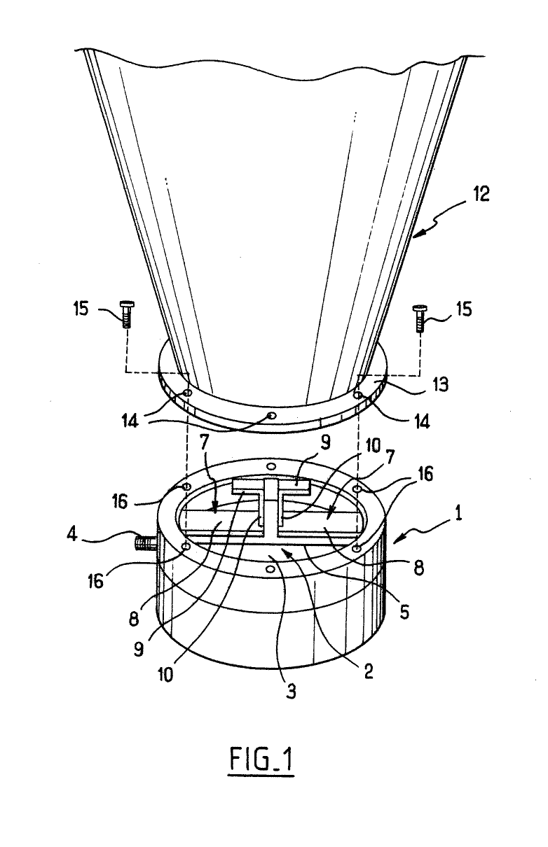

FIG. 1 is an exploded perspective view of the coupler according to the invention mounted with a horn antenna,

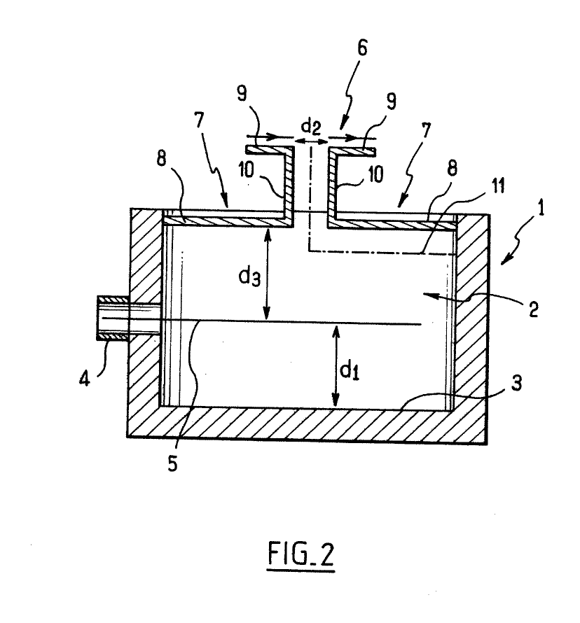

FIG. 2 is a diagrammatic radial cross-sectional view of the coupler according to the invention illustrated in FIG. 1.

We will describe below an OMJ coupler with a medium and broad bandwidth according to the invention in order to separate orthogonal dual-polarization bands of a circular feed horn coaxial to or charged from a dielectric cone; however, it is obvious that the coupler according to the invention may be used alone and/or in any other application well known by One Skilled in the Art.

In reference to FIGS. 1 and 2, the coupler according to the invention is made up of a cylindrical waveguide 1 comprising a coaxial cylindrical cavity 2 the bottom of which forms a short circuit 3 of said waveguide 1.

Said waveguide comprises, on its lateral wall, an inlet port 4 from which a connector 5 projects, said connector consisting of a conducting rod electrically isolated from said waveguide, said conducting rod 5 being electrically isolated at radiofrequencies and not at pulsing current. This conducting rod 5 emerges in the cylindrical cavity 2 of the waveguide 1 while extending diametrically in said cavity. The distance d₁ separating the conducting rod 5 from the short circuit 3 of the waveguide is approximately equal to one quarter of the wavelength λ of said waveguide 1, or d₁=λ/4.

Furthermore, said waveguide 1 comprises, near its upper end, a conducting structure 6 acting as a dipole radiating at the wavelength λ/2.

This conducting structure 6 consists of two fins 7, C-shaped or U-shaped, respectively, extending symmetrically on either side of the axis of revolution of the waveguide 1, and more precisely symmetrically on either side of the plane of symmetry of the waveguide 1 extending orthogonally to the conducting rod 5 and passing through the axis of revolution of said waveguide 1.

Each fin 7 comprises a first, so-called lower branch 8 integral with the waveguide 1 and extending above the conducting rod 5 and parallel thereto toward the plane of symmetry of said waveguide 1 and a second, so-called upper branch 9, shorter than the lower branch 8, extending parallel to the lower branch 8 above it, said branches 8 and 9 being connected by a vertical base 10 extending perpendicular to the conducting rod 5.

The conducting structure 6 will advantageously be obtained in a metallic material.

Secondarily, in order to avoid the appearance of a parasite mode in the waveguide 1, the latter part comprises a filter positioned between the two orthogonal excitation structures.

It is obvious that the filter may consist of several conducting rods, the ends of which are connected to the waveguide or any other equivalent means well known by One Skilled in the Art without going beyond the scope of the invention.

Thus, the conducting rod 5 capacitively supplies the conducting structure 6 such that an excitation current runs through the upper branches 9 of the conducting structure 6, said excitation currents being illustrated by arrows in FIG. 2. The excitation currents of the upper branches 9 correspond to the distribution of the currents on an equivalent dipole. In reference to FIG. 1, an antenna horn 12 comprising a flange 13 at its base provided with a hole 14 may be secured to the end of the coupler using screws 15 cooperating with threaded holes 16 formed on the upper edge of the waveguide 1.

A coaxial orthogonal-mode junction coupler of this type operating on a medium to broad frequency band obtains weak coupling between the ports such that an external compensating circuit is not necessary.

It is obvious that the coupler according to the invention may be obtained according to a precision trimming method well known by One Skilled in the Art or a method for manufacturing a multi-layer printed circuit, said multi-layer printed circuit being integrated into a waveguide, without, however, going beyond the scope of the invention.

Lastly, it goes without saying that the orthogonal-mode junction (OMJ) coupler with a medium or broad bandwidth according to the invention may be adapted for any other application well known by One Skilled in the Art and that the examples which were just provided are in no way limiting as to the fields of application of the invention.

1. An orthogonal-mode junction coupler with a medium to broad bandwidth for a waveguide (1) operating at a wavelength λ, characterized in that it comprises a connector (5) projecting from the waveguide (1) and extending between a short circuit (3) of the waveguide (1) and a conducting structure (6) acting as a dipole radiating at a wavelength of approximately λ/2 excited at its central point by the connector.

2. The orthogonal-mode junction connector according to claim 1 characterized in that the connector (5) consists of a conducting rod electrically isolated from the waveguide (1) and capacitively supplying the conducting structure (6).

3. The orthogonal-mode junction connector according to any one of claim 1 or 2 characterized in that the conducting structure (6) consists of two fins (7), C-shaped or U-shaped, respectively, extending symmetrically on either side of the plane of symmetry of the waveguide (1), each fin (7) comprising a first branch (8) integral with the waveguide (1) and extending above the connector (5) and parallel thereto toward the plane of symmetry of said waveguide (1) and a second branch (9) extending parallel to the first branch (8) above the latter part, said branches (8, 9) of each fin (7) being connected by a vertical base (10) extending perpendicularly to the connector (5).

4. The orthogonal-mode junction connector according to any one of claims 1 to 3, characterized in that the distance d₁ separating the short circuit (3) of the waveguide (1) from the lower connector (5) is approximately equal to one quarter of the wavelength λ of the waveguide (1).

5. A method of orthogonal-mode junction coupling with a medium to broad operating bandwidth for a waveguide (1) with a wavelength λ characterized in that it consists of capacitively supplying a conducting structure (6) integral with the waveguide (1) through a connector (5) projecting inside the waveguide (1) and extending between a short circuit (3) of said waveguide (1) and the conducting structure (6).
